(19) United States
(12) Patent Application Publication
(10) Pub. No.: US 2009/0044568 A1
(43) Pub. Date: Feb. 19, 2009

(54) Submerged fired vertical furnance

(76) Inventor: Albert Lewis, Chino, CA (US)

Correspondence Address: Boniard I. Brown, 1710 West Cameron Ave., #200, West Covina, CA, 91790, US

(21) Appl. No.: 11/893,143

(22) Filed: Aug. 15, 2007

(51) Int. Cl. C03B 5/16

(52) U.S. Cl. 65/134.4; 75/414

(57) ABSTRACT

A furnace is heated by submerged heating equipment. An exhaust stack is vented directly to outside the furnace. A portion of hot gases may pass into at least one shaft via which incoming material and a stage of pre-heating occurs.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND AND SUMMARY OF THE INVENTION

The present invention relates to furnaces which are heated by submerged heating equipment which may be gas, oxy/gas or electrically fired.

Water cooled melting furnaces have been used for some years to melt a variety of materials such as metal, rock, glass, etc. Water cooled furnaces for melting glass began in the 1970's. Several types of energy have been utilized, such as electric, gas, and coke.

Conventional cupola furnaces have typically utilized solid coke fuel. Such furnaces have been relatively efficient, but have major shortcomings, including poor quality of the melt, and that the firing of solid coke produces a relatively high degree of air pollution.

The present invention eliminates these shortcomings and certain other problems associated with conventional water cooled melting furnaces.

In accordance with the invention, heat for melting is provided by submerged electrodes and/or gas burners using gas or oxy/gas, without utilizing other types of fossil fuels and the like.

An air/gas or oxy/gas mixture is utilized, and the heat of exhaust gases is efficiently utilized for the pre-heating of incoming material, which moves generally downwardly as in traditional furnaces.

The output or “melt” of the furnace is very homogenous as compared with conventional prior art melts.

The vertical melting shaft may preferably be disposed using a gas/oxy burner or submerged electrodes directly above a melt pool, or it may be offset relative to the melt pool, as indicated in FIG. 1.

Batch materials are charged into a melting chamber at the entrance of the melting shaft, as by being pushed by a reciprocating ram, a screw, or a vibrating screen, etc. (not shown) into the melting chamber. A shaft according to FIG. 1 is utilized, and may be pushed into the melting chamber.

An exhaust stack is vented via the stacks directly to the outside of the furnace. A portion of the hot gases may pass into the vertical shaft or shafts through which incoming material passes, and where a first stage of pre-heating occurs.

### BRIEF DESCRIPTION OF THE DRAWINGS

FIG. 1 is an overall view of the submerged fired vertical furnace according to the present invention.

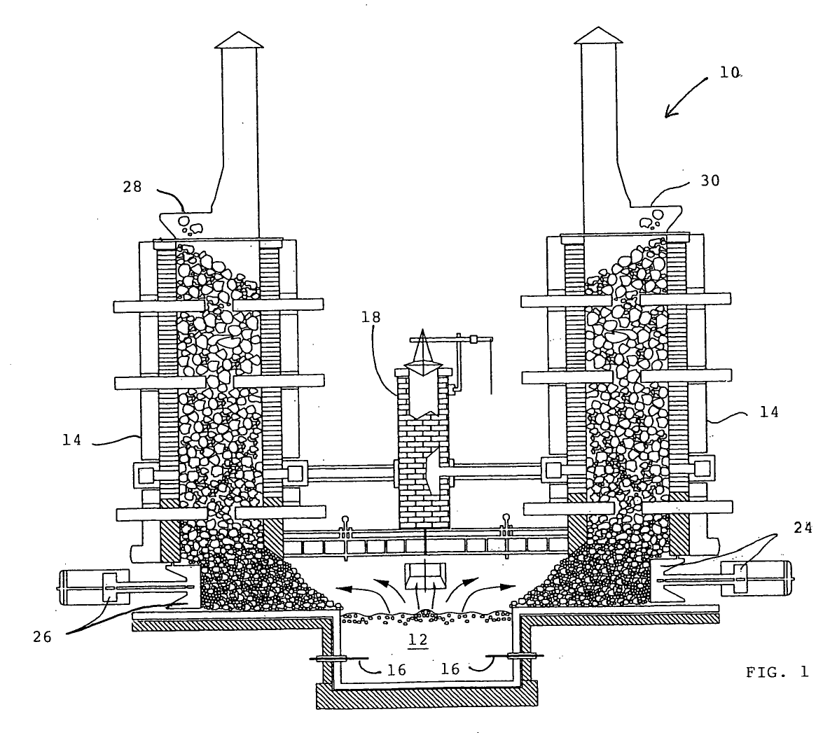

### DETAILED DESCRIPTION OF THE INVENTION

The present invention relates to a substantially vertical shaft melting furnace wherein solid charge is continuously added and passes downwardly to hot combustion gases in a preheated and sized reduction melting zone, providing intensive preheating and melting of the charge using electricity or heat of combustion gases.

Prior art conventional melting and heating furnaces are generally reverberatory furnaces and cupolas. Reverberatory furnaces have been very expensive in capital cost and in operation, and have provided low production rates and low thermal efficiency.

The present invention is a continuous melting furnace which is gas or electrically fired and relates generally to substantially vertical melting furnaces in which charge is continuously added. The burners utilized with the invention may be of any suitable design, and oxidizing gas may preferably be provided.

A vertical shaft furnace 10 has a melt pool 12 at the bottom thereof and communicating with meltable solids passing through water jackets 14 on opposite sides of the furnace.

Referring to the drawing, submerged heating in a melt pool 12 produces gases some of which pass upwardly in water jackets 14 to produce a melt which extends downwardly toward the melt pool 12 which melts any remaining portion of solids coming through the water jackets. A chimney 18 extends vertically above the melt pool.

Material which is added through charge entry ports 28, 30 may be mixed with melts in the melt pool 12 by intensive melt current resulting from submerged heating. Submerged burners or electrodes 16 are installed in the walls of the melt pool.

Gases from the melt pool 12 pass to and heat lower portions of the opposite vertical shafts or water jackets 14 through which incoming material passes.

Submerged combustion is maintained in the melt pool to produce combustion product gases which pass upwardly through the solids to preheat and melt a portion of the solids to form melt which flows downwardly into said melt pool to at least partially melt a remaining portion of said solids to reduce their size sufficiently to pass through support grid openings and into said melt pool.

Preferred embodiments of the present invention typically utilize gas burners or electrode equipment in the melt pool 12, and use a computer program to control glass flow.

In a preferred embodiment of the invention shown in the drawing, burners or tuyeres may be employed for added control and/or submerging heating. The burners (not shown) utilized may be of any suitable known design.

The partially melted solid charge particles are reduced in size after passing through a melting zone. Melting is completed by submerged heating, which provides high heating intensity and high heat transfer to the melt.

Submerged heating provides intensive convection currents in the melt, high heat and transfer rates between the melt in the collection zone, fresh melt and charge particles entering the melt resulting in rapid melting of these particles.

Some gases may be guided into the vertical feed shafts to carry incoming material.

A melting system comprises one or more feed shafts in the furnace wherein material is mixed with melt in a melt pool 12 at the bottom of the furnace. Intense currents are produced by submerged heating.

The charge is supported on a coolant distribution grid having openings smaller than the average diameter of the solid charge material and/or the glass viscosity. The charge flows downwardly through the submerged melt pool which is generally at the bottom of the furnace.

Partially melted charge particles are reduced in size after passing through the preheating melting zone so that the particles reaching the coolant grid are of sufficiently small size to pass with the melt through the coolant grid area. Melting is completed by submerged heating which involves high heat transfer between the melt and a collection zone. The melt and charge particles enter the melt for rapid melting.

Unmelted granular material is charged into the upper end of a melting shaft, and is inserted into the upper end of the shaft. It may be urged slowly sideways by reciprocating rams 24, 26, and into a melting chamber. At least a major portion of the melting occurs at the front face of the granular material, and is slowly charged into the melting chamber.

An exhaust stack communicates with the furnace. A portion of hot gases is vented outwardly via a stack, as during furnace start-up and operation, or, the gases are guided into the vertical shaft.

Submerged heating is maintained in the melt pool, and produces product gases some of which pass upwardly through the bed of solids and melt a portion thereof to form a melt extending into the melt pool to melt any remaining portion of the solids, with solids passing through the grid opening into the melt pool.

It will be understood that various changes and modifications may be made from the preferred embodiment discussed above without departing from the scope of the present invention, which is established by the following claims and equivalents thereof.

1. A method of melting solids in a furnace comprising:
providing a submerged pool at a lower portion of a vertical melting furnace or to a horizontal extension thereto,
providing an exhaust stack spaced from at least one water jacket through which incoming material passes,
means to maintain heat in said pool comprising at least one submerged electrode or burner, and
wherein said means to maintain heat in the melt pool comprises a feeding shaft on at least one side of said furnace.

2. A method according to claim 1 wherein said burner is a oxy/gas burner.

3. A method according to claim 1 wherein said material is mixed by incoming currents produced by combustion from said submerged burner or electrode.

4. A method according to claim 1 wherein a feeding shaft is disposed on each of the opposite sides of the furnace.

5. A method for melting solids in a vertical melting furnace, comprising:
charging solid materials into at least one bed of solids disposed in a lower portion of the furnace,
charging melted solids into at least one feeding shaft of the melting furnace, and
submerging oxy/gas burner or electrode means to maintain heat in a melt pool at said lower portion of the furnace.

6. A method according to claim 5 wherein a water jacket is in communication with the melt pool to conduct incoming solids to the melt pool and provide mechanical control to the glass flow control.

7. A method according to claim 5 and further comprising a feeding shaft disposed on one or each of opposite sides of the furnace.

8. A method according to claim 6 wherein the glass flow is managed using glass viscosity in the various zones that is controlled using impedience or resistance in each zone.

9. A vertical melting furnace comprising:
a melt pool in a lower portion of a horizontal extension of the furnace and communicating with input material,
at least one water jacket in communication with the melt pool to conduct incoming solids to the melt pool to control glass flow, and
means for maintaining submerged heating in said melt pool, whereby hot gases pass upwardly to incoming solids to pre-heat and melt portions of said solids to form a melt which flows downwardly into the melt pool.

10. A melting furnace according to claim 9 wherein the submerged combustion is maintained by submerged oxy/gas burner means.

11. A melting furnace according to claim 9 and having an input feeding shaft on each of two opposite sides of the furnace.

12. A melting furnace according to claim 9 and further comprising a glass flow control system permitting glass flow control utilizing glass viscosity.

13. A glass flow control system according to claim 9 utilizing electric, gas, and/or oxygen/gas burners.

14. A vertical melting furnace for melting solids, comprising:
a submerged melt pool at a lower portion of the vertical melting furnace or to a horizontal extension thereto,
an exhaust stack spaced from at least one water jacket through which incoming material passes,
at least one submerged electrode or burner for maintaining heat in said pool, and
a feeding shaft on at least one side of said furnace.

15. A melting furnace according to claim 14 wherein said burner is a oxy/gas burner.

16. A melting furnace according to claim 14 wherein said material is mixed by incoming currents produced by combustion from said submerged burner or electrode.

17. A melting furnace according to claim 14 wherein a second feeding shaft is disposed on a side of said furnace from said at least one side.

18. A melting furnace according to claim 14 further comprising a water jacket in communication with the melt pool to conduct incoming solids to the melt pool and to provide mechanical control to the flow of molten material therethrough.

19. A melting furnace according to claim 14 wherein the at least one water jacket is in communication with the melt pool to conduct incoming solids t9 the melt pool and provide mechanical control to a glass flow control.

20. A melting furnace according to claim 12 wherein the glass flow is managed using glass viscosity in the various zones that is controlled using impedience/resistance in each zone.
